(19) United States
(12) Patent Application Publication
(10) Pub. No.: US 2003/0212818 A1
(43) Pub. Date: Nov. 13, 2003

(54) Content based message dispatch

(76) Inventors: Johannes Klein, Sammamish, WA (US); Lee Graber, Kirkland, WA (US); Sanjib Saha, Bellevue, WA (US); Bimal Kumar Mehta, Sammamish, WA (US); Jean-Emile Elien, Bellevue, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/141,464

(22) Filed: May 8, 2002

(51) Int. Cl. G06F 15/173

(52) U.S. Cl. 709/238; 709/219

(57) ABSTRACT

Systems and methodologies are disclosed to facilitate for routing messages in a communications framework, which can include one or more computers. Determinations as to whether and where to route messages are based at least in part upon the content of messages. Services interested in receiving messages specify one or more subscriptions, which are employed to make routing decisions for messages. The subscriptions are evaluated relative to messages, and more particularly content based message properties of respective messages, to determine whether and where to route messages.

### TECHNICAL FIELD

The present invention relates to network communications, and more particularly to routing messages within a network based on message content.

### BACKGROUND OF THE INVENTION

Within computer networks, messages are typically routed between machines according to respective identifiers assigned to endpoint machines. On the Internet, for example, messages are routed between computers by way of unique Internet Protocol (IP) addresses assigned to the computers. More particularly, respective computers connected to the Internet are assigned unique IP addresses, such as 12.131.32.31. Routers determine where data packets are to be sent, so that particular packets of information arrive at intended destinations based upon, among other things, the respective IP addresses of destination endpoints included in the messages.

Uniform Resource Locators (URLs) are frequently associated with unique IP addresses to provide logical names for endpoints that users can more easily remember. However, this necessitates an additional step of translating URLs to their IP counterparts before messages can be sent to corresponding machines. This is accomplished by Domain Name Servers (DNSs), which intercept messages and perform DNS name resolutions prior to routing messages.

These conventional routing techniques are not completely satisfactory for all situations. For example, a service or application may have multiple instances executing simultaneously, such as may correspond to one or more ongoing transactions. Each of the transactions may comprise multiple aspects or stages, including, for example, order processing, shipping, inventory control, credit history, accounts payable, and the like. The different transactions are carried out on respective instances of the originating service or application.

Depending upon various factors, such as, for example, the type of transaction, the different stages of the transactions may or may not occur in the same order on each of the respective instances. Additional uncertainty exists since respective stages of the transactions may or may not occur within a similar time frame and/or on the same endpoint machine. Thus, a message regarding an aspect of one of the transactions may need to be routed to one or more specific service instances executing on one or more endpoints, which may or may not be the same as the machine hosting the service or application from which the transaction originated. Stated another way, this information, or portions thereof, may need to be routed to different endpoint machines for processing on respective service instances.

### SUMMARY OF THE INVENTION

The following presents a simplified summary of the invention in order to provide a basic understanding of some aspects of the invention. This summary is not an extensive overview of the invention. It is intended neither to identify key or critical elements of the invention nor delineate the scope of the invention. Its sole purpose is to present some concepts of the invention in a simplified form as a prelude to the more detailed description that is presented later.

The present invention relates to systems and method that facilitate message dispatch or routing based at least in part on content of the message. According to an aspect of the present invention, determinations as to whether and where to routed messages are based, at least in part, upon the content of messages. Services or service instances interested in receiving messages specify one or more subscriptions which are defined on or include content-based message criteria. The subscriptions are maintained within and utilized by a dispatch engine to make routing decisions. The dispatch engine evaluates messages, and more particularly content based message properties, against the subscriptions to determine whether and where to route messages.

Subscriptions include one or more filters made up of condition-action pairs. Conditions indicate the content-based criteria that are required for a message to satisfy the subscription. Actions indicate to where (and possibly when) the message is to be routed (e.g., the address of an endpoint hosting the service from which the subscription originated) if the message satisfies the subscription.

According to another aspect of the present invention, a messages itself can contain attributes or properties that restrict the subscriptions against which the respective message can be evaluated. This is particularly useful for secure routing of decrypted messages.

Another aspect of the present invention employs a locking mechanism to inhibit concurrent access to a service instance so as to not interrupt processing of a message by that service instance. For example, a service can acquire an instance lock relative to a message placed in its respective message queue. The lock can be removed after the service instance has completed processing of the message.

According to one or more aspects of the present invention, a system to facilitate routing of messages includes at least one filter associated with a service. For example, the service specifies content attributes and values to define a type of message that it may be interested in receiving. The filter thus includes filter criteria indicative of message content. The system also includes a dispatch engine operative to receive a message and to route the message to the service if at least some content of the message satisfies the filter criteria specified by that service. According to yet another aspect of the present invention, a method to facilitate routing messages includes accessing a message that includes message properties based at least in part on content of the message. The message is evaluated relative to at least one subscription associated with a service, where the at least one filter includes filter criteria indicative of message content. There often will be a plurality of subscriptions against which the message is compared. The accessed message to the service based on at least some of the message properties satisfying the filter criteria for that service.

To the accomplishment of the foregoing and related ends, certain illustrative aspects of the invention are described herein in connection with the following description and the annexed drawings. These aspects are indicative, however, of but a few of the various ways in which the principles of the invention can be employed and the present invention is intended to include all such aspects and their equivalents. Other advantages and novel features of the invention can become apparent from the following detailed description of the invention when considered in conjunction with the drawings.

### BRIEF DESCRIPTION OF THE DRAWINGS

FIG. 1 is a schematic block diagram illustrating a system to route messages in accordance with one or more aspects of the present invention.

FIG. 2 is a schematic block diagram illustrating a system to facilitate message routing in accordance with one or more aspects of the present invention.

FIG. 3 schematically illustrates a data structure for a message configuration according to one or more aspects of the present invention.

FIG. 4 illustrates an exemplary message that can be routed according to one or more aspects of the present invention.

FIG. 5 illustrates an exemplary representation of messages stored in a data store according to one or more aspects of the present invention.

FIG. 6 illustrates an example of a subscription which can be registered by a subscribing service in accordance with an aspect of the present invention.

FIG. 7 is a schematic illustration of a condition according to one or more aspects of the present invention.

FIG. 8 is an illustration of an exemplary table containing conjuncts in accordance with one or more aspects of the present invention.

FIG. 9 is an illustration of an exemplary table containing predicates in accordance with one or more aspects of the present invention.

FIG. 10 is a schematic block diagram illustrating a system for routing messages in accordance with one or more aspects of the present invention.

FIG. 11 is a schematic block diagram illustrating a system for routing messages according to one or more aspects of the present invention.

FIG. 12 illustrates an exemplary operating environment in which the present invention may function.

FIG. 13 is a schematic block diagram of an exemplary communication environment in accordance with the present invention.

FIG. 14 is a flow diagram illustrating a basic methodology for routing a message in accordance with an aspect of the present invention.

FIG. 15 is a flow diagram illustrating a methodology for routing a message in accordance with an aspect of the present invention.

FIG. 16 is an example of a process for posting a message to a database is in accordance with an aspect of the present invention.

FIG. 17 is an example of a process for creating a subscription in accordance with an aspect of the present invention.

FIG. 18 is an example of a process illustrating a lifecycle for a service instance associated with a message in accordance with an aspect of the present invention.

FIG. 19 is a state diagram illustrating an example of possible states for a message being routed in accordance with an aspect of the present invention.

### DETAILED DESCRIPTION OF THE INVENTION

The present invention relates to systems and methodologies to facilitate for routing messages. Determinations as to whether and where to route messages are based at least in part upon the content of the messages. Services interested in receiving messages specify one or more subscriptions, which are evaluated relative to the messages to control routing.

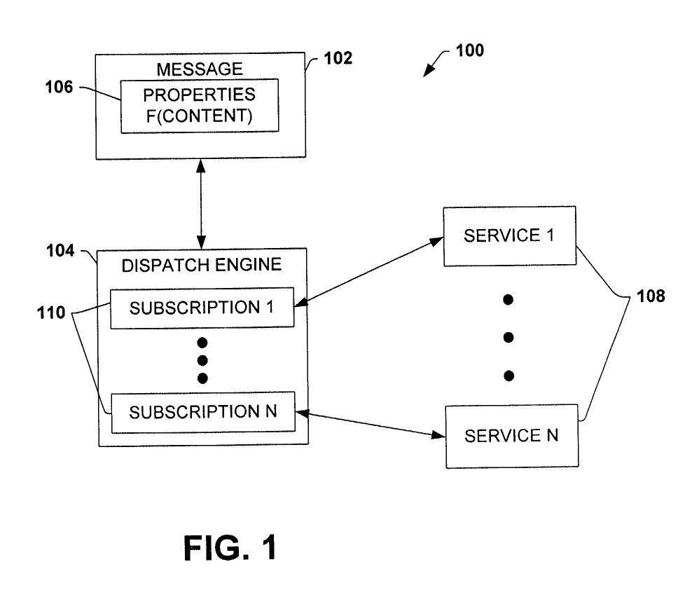

FIG. 1 is a schematic block diagram of a system 100 adapted to route messages 102 in accordance with one or more aspects of the present invention. The system includes a dispatch engine 104 programmed to operate as a message switch and route messages 102 based on message properties 106. The message properties 106 are a function of, among other things, message content. The dispatch engine 104 receives messages from various transport endpoints (not shown) and routes such messages to one or more (e.g., 1−N, N being a positive integer) registered or subscribing services 108. The services, for example, may be hosted on the same or different transport endpoints from which the messages originate. For purposes of the discussion herein, endpoints can include any compliant resources from which messages can originate as well as any compliant resources to which message may be sent (e.g., service hosts).

The dispatch engine 104 includes one or more (e.g., 1−N, N being a positive integer) subscriptions 110 which are provided by services desirous of receiving messages. The subscriptions 110 contain one or more filters (not shown) which define, among other things, one or more conditions, which are required to be satisfied before messages can be routed to subscribing services. For example, a given service can define a set of filter criteria corresponding to metadata identifying message properties that, if present in a message, associate that message with the given service.

The dispatch engine 104 employs the respective filters to decide whether particular messages 102 should be routed to particular services 108. That is, the dispatch engine 104 performs routing based upon matches between message properties 106 and filters, where the message properties are a function of, among other things, message content. Thus, when properties of a message 102 match properties defined in a filter, the message 102 is allowed to pass through the filter and is routed to the subscribing service 108 with which the filter is associated. The system 100 is dynamic in that message routing can be performed while new filters are added and existing filters are deleted.

It is to be appreciated that subscription filters can be applied in phases such that some filters are only encountered after messages have pre-qualified or traversed initial filters. Such phase filtering techniques can greatly reduce search space and improve performance of the dispatch mechanism. It is to be further appreciated that once a message is received at a service and (optionally) processed thereby, a response (e.g., an acknowledgement or confirmation message) may be sent back to the originator of the message. For example, the reply message can be routed to the originator using subscriptions and content based routing as described herein by making the sender property the receiver property of the reply according to an aspect of the present invention. It is to be appreciated that alternatively the subscriptions and filtering can be employed in conjunction with originating messages only since the service processing the message can ascertain the originator's address from information contained in the message (e.g., header information) and utilize this address to thus route a return message by employing other transport mechanisms.

It is to be further appreciated that, as used herein, the term “message” is to be interpreted broadly to include any type of communication (e g., email, business transaction, online purchasing transaction, purchase order, invoice, sales forecast, other business information and so forth). A message may be a multi-part package of documents and data constituting a unit of communication. Messages can include attachments, such as, for example, images, large compressed files, or any other information that may be externally or internally associated with the message. The structure of a message may depend upon the transport used to carry the message and, as such, a message may include transport-specific headers.

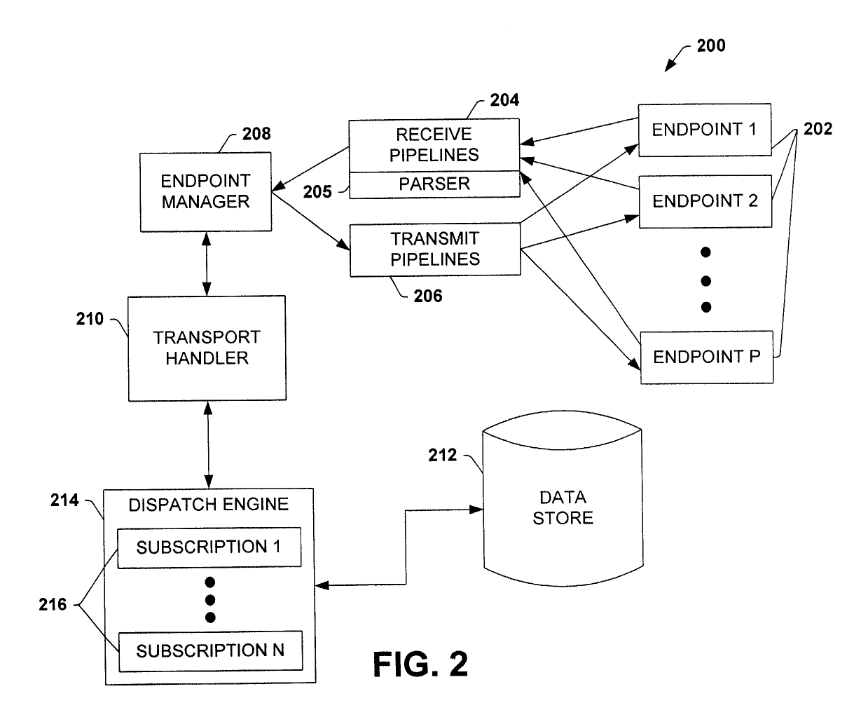

FIG. 2 illustrates a system 200 to facilitate message routing in accordance with an aspect of the present invention. Receive and transmit pipelines 204 and 206, respectively, service messages relative to corresponding endpoints. In the illustrated example, incoming messages (not shown) originating from one or more (e.g., 1−P, P being a positive integer) endpoints 202 are received on receive pipelines 204. Similarly, outgoing messages (not shown) are sent through transmit pipelines 206 to subscribing services (not shown) hosted on the same or different endpoints 202 as those from which messages originated. Pipelines 204, 206 tie together built-in or custom processing steps during data interchange and facilitate customization of digital certificate identification and processing. Pipelines 204, 206 allow messages to be processed based on values in user-specified fields of a message (e.g., content).

By way of illustration, receive pipelines 204 are utilized to, among other things, decrypt, decode, authenticate and parse incoming messages into an appropriate representation (e.g., XML). The receive pipeline includes a parser 205 operative to parse the incoming message to extract content properties. The parser 205 can extract or derive message properties based on the content of the message. For example, the message properties can be derived from a body portion of the message as well as based on transport header information in the incoming message. By way of example, the parser can implement an open ended set of parsers (e.g., EDI, comma separated files, RosettaNet). The parsed messages, including extracted message properties, are posted or stored in a data store (e.g., a database) for further processing in accordance with an aspect of the present invention. The posted message, for example, includes the message properties (or at least a selected subset of the properties) as well as one or more message parts corresponding to original message data from the incoming message. Posted messages can be stored in the data store, such as according a common internal representation in one or more databases.

Receive pipelines 204 can also authenticate message originators and perform access checks for an incoming message. Messages originating from endpoints 202 which cannot be authenticated or are not authorized to deliver messages are either discarded or routed to a suspended queue (not shown) for error handling.

Transmit pipelines 206 are utilized to, among other things, envelope, sign, encrypt and serialize outgoing messages. Pipelines 204, 206 may be customized for particular design needs of different transport endpoints (e.g., for compression, encryption-decryption, transport protocols). Content properties (e.g., corresponding to metadata of respective messages) may be utilized in association with transport properties for routing messages to actual services hosted on endpoints 202. Pipelines 204, 206 may also associate security related information with messages that may be utilized in subsequent processing stages.

The pipelines 204, 206 are operatively coupled to an endpoint manager 208 which loads and executes the message pipelines 204, 206 configured for respective endpoints 202. The endpoint manager 208 is hosted by a transport handler 210 which interfaces a with the endpoints 202 through the endpoint manager 208 and corresponding pipelines 204, 206. The transport handler 210 receives incoming messages and inserts them into a data space or data store 212 via a dispatch engine 214. The data store, for example, provides a queue or other data structure for storing respective messages processed by services as described herein. The transport handler 210 also forwards outgoing messages to remote endpoints 202 via the endpoint manager 208 and respective pipelines 204, 206. The transport handler 210 is a type of service, which may generate subscriptions to route messages to particular service types which may need to be sent on particular associated transport types. The transport handler may also assist with extracting message properties (e.g., from message headers) from received messages.

Other services specify one or more (e.g., 1−N, N being a positive integer) subscriptions 216 which comprise one or more filters (not shown) to register interest in receiving messages (e.g., via web service definition language (WSDL) interfaces). More particularly, services are hosted by applications executing on endpoints 202 and indicate a desire to receive messages by specifying subscriptions 216 that contain filters defined on message properties. Any service interested in receiving messages can selectively generate one or more filters for a subscription. The filter can include a set of one or more conditions, which are based on message content, and actions to perform is the condition(s) are satisfied. Services can also supply endpoint specific pipeline configuration parameters. For instance, information provided by services can be utilized to configure one or more pipelines for authorization purposes by providing a particular set of certificates and identifying which certificates or private keys to use for decrypting messages.

By way of example, filters comprised within subscriptions 216 originating from subscribing services can be Boolean expressions in disjunctive normal form. Such subscription filter expressions can contain, for example, a fixed set of comparison operators (e.g., =, <, >, ≈, ≠, =, =) to identify a relationship for each property in the filter relative to a value or a set of values. The subscriptions 216 are fed into the dispatch engine 214 by the by the particular service that created the subscription wherein they are housed and executed. The dispatch engine 214 interfaces with the data store 212 and, when messages are posted to the data store 212, the dispatch engine can compare or evaluate the messages relative to filters in subscriptions 216. Messages having properties that match a subscription 216 are dispatched to the endpoint 202 hosting the services with which the matching subscription filter is associated.

In accordance with another aspect of the present invention, another type of filter that may be implemented to assist with message routing is a reverse filter. Reverse filters can be associated with or contained within messages (e.g., as annotations similar to message properties) so as to restrict, or filter out, the set of subscriptions 216 against which messages may be adjudged. Such filters may be referred to as a reverse filter since they restrict the set of subscription (e.g., to a subset of the subscriptions) that can be applied to particular messages.

By way of illustration, reverse filtering is particularly useful to facilitate secure routing of decrypted messages to only those service hosts for which the messages are intended. That is, the reverse filter of a message itself can be employed to help ensure that a decrypted message is routed to only those services owning the private key used for decryption. For example, the reverse filter can include an identifier for the private key, which is employed to restrict application of the message to those filters having the corresponding identifier. In this way, the likelihood of routing a secure message erroneously to the wrong service is mitigated.

It is to be appreciated that while one data store is shown in FIG. 2, multiple data stores may be utilized for scale out. In such an arrangement, a simple round robin or hash-based algorithm may be utilized to allocate messages among the databases. For example, a master subscription table can be maintained at a central location to correlate messages with databases. Thus, before routing a message, the dispatch engine 214 would query the master table to ascertain which data store the message is maintained within.

It is to be appreciated that for purposes of the present invention, data stores may be comprised of any type of structure having any arrangement or configuration facilitating desired retrieval, storage and/or searching not departing from the spirit and scope of the present invention (e.g., combination or individual implementation of two dimensional arrays, three dimensional arrays, relational databases, object-oriented databases, object-relational databases, data tables, database access libraries, queues, stored SQL procedures, other searchable structures). A database structure, for example, can enable fast and complex queries to be performed, while one or more relationship tables can enable search results to automatically be cross referenced against information in other tables.

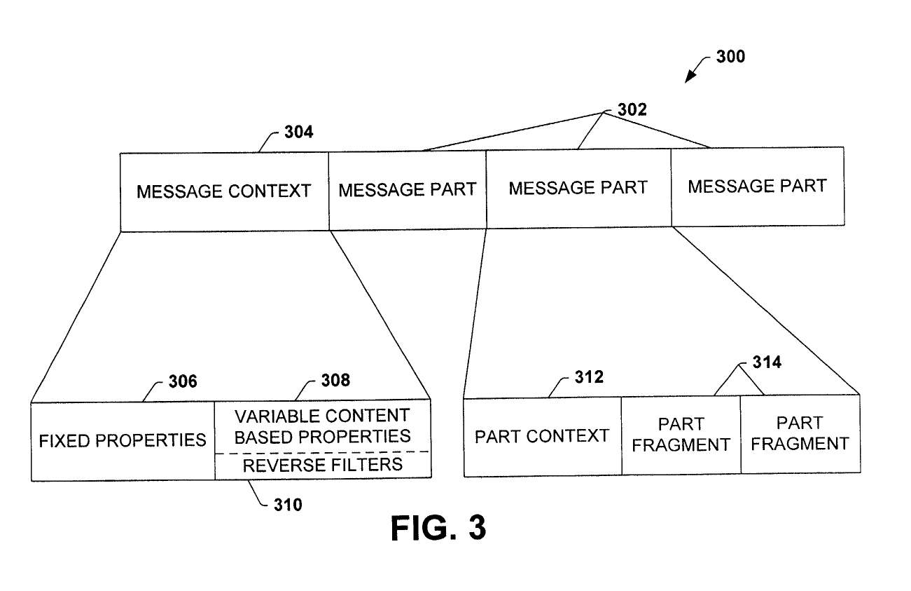

FIG. 3 schematically illustrates a data structure 300 for a message configured in accordance with one or more aspects of the present invention. The message 300 is composed of one or more parts 302 and a message context 304. The context 304 includes a collection of named properties, at least one of which is metadata based on the content of the message. The message properties can be stored according a predefined XML schema, for example, although other formats and languages could be utilized. In this example, the message context contains a fixed set of properties 306 and a variable set of properties 308.

The fixed set of properties 306 in the message context 304 may include, among other things, expiration date, message originator and a unique user defined message identifier which may be retained until an expiration timestamp expires. Message identifiers can be utilized to detect duplicates and to assemble incomplete messages, such as those arriving in fragments (e.g., fragments having the same identifiers can be assembled together based on message identifiers).

The variable set of properties 308 includes, among other things, a variable set of transport and user defined content-based properties. For example, the properties are typed name, value pairs and include among other things, destination endpoint, transport protocol, document type, identity of message sender and other properties extracted from the message or set by transport components.

In accordance with an aspect of the present invention, the message 300 also can include annotations (e g., similar to message properties) that define one or more reverse filters 310. A reverse filter restricts the set of subscription filters against which the message can be compared as described herein. There can be positive or negative reverse filtering. For example, a positive reverse filter enables access to a message by a subscription filter if the message includes reverse filter criteria that matches subscription properties of the filter. A negative reverse filter operates to exclude application of subscription filters that match subscription properties of the message's reverse filter. Thus, reverse filtering mitigates unnecessary message filtering by subscriptions that are received from services that are not intended to receive certain messages. This is particularly useful for secure routing of decrypted of messages to only the owner(s) of the private key use to decrypt the message, as the private key and/or owner information can be employed to define a corresponding reverse filter. Accordingly, only those subscriptions having properties that include the owner or key information can process a message with such a reverse filter.

Message parts 302 are uniquely identified by part identifiers. Parts can be generic and may be reused across different messages. Within a message, a part is identified by the part name or another identifier. For instance, one part of a message may be designated as the message body, while another part of the message may be designated as the message header. It is to be appreciated that a given part, which can be common to multiple messages, may have different names in different messages. For example, a part can be the body part of one message and at the same time can be one of the satellite parts of another message. The various parts of a message are bound together using a message identifier (ID). Message parts may include a part context 312 for storing part specific properties and one or more part fragments 314. Parts are generally all that is seen by endpoint recipients when viewing messages, as the other features of the message can be stripped away by interfaces during routing.

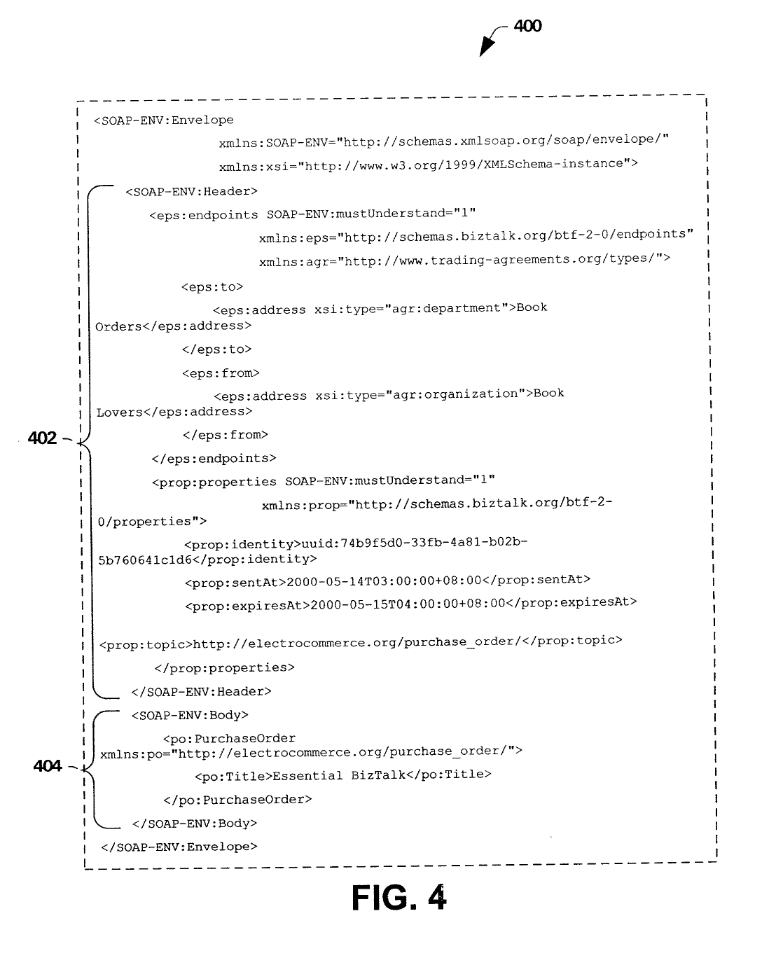

FIG. 4 illustrates an example of a message 400 that can be routed in accordance with one or more aspects of the present invention. The message 400 includes a header part 402 and a body part 404 and, in the example shown, contains an application-specific document (e.g., a book purchase order embodied as a SOAP message). The body 404 of the message contains several related application specific documents (e.g., purchase order, shipper's name and address for shipping the order). The header 402 of the message 400 contains several specific entries (e.g., message identity, source and destination). It is to be appreciated, however that this is but one type of message that can be routed according to the present invention.

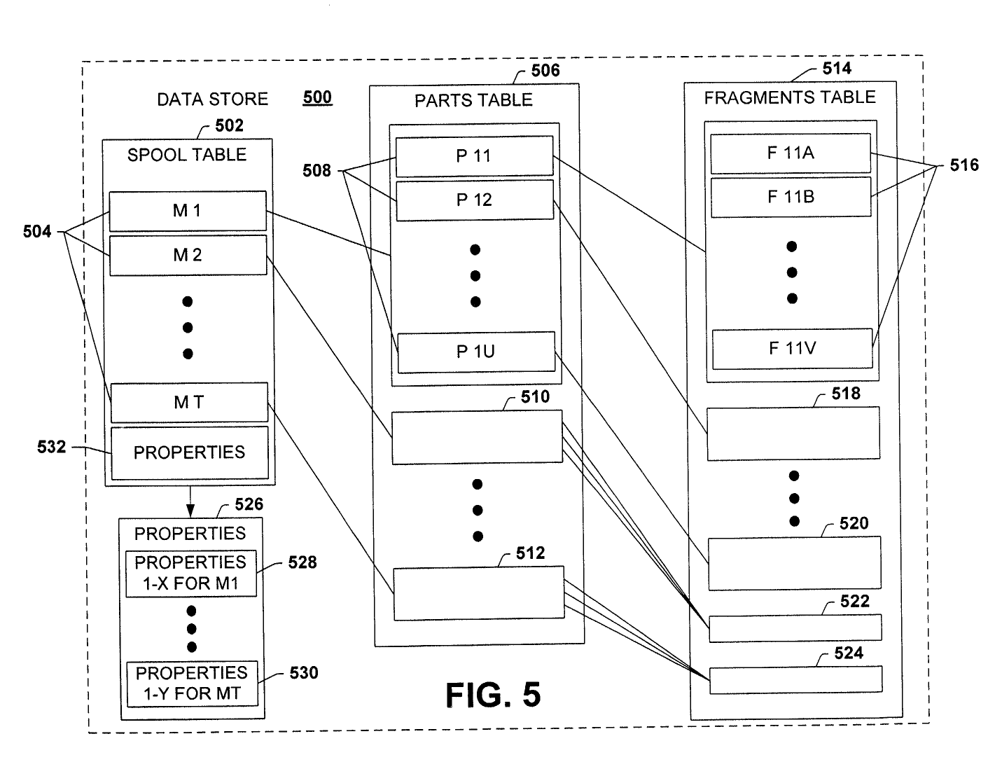

Turning now to FIG. 5, an exemplary representation of messages stored in a data store 500 according to one or more aspects of the present invention is illustrated. The data store 500 includes a spool table 502, which has entries for one or more (e.g., M1−MT, T being a positive integer) messages 504. Each message can include one or more parts. Each message 504 as well as its parts are bound together using a message ID, which ID can be employed to reference respective message, for example. The system also includes a parts table 506 that stores and associates one or more parts 508 with respective messages stored in the spool table 502. For instance, in the example illustrated, the parts table 506 includes entries P11-P1U (U being a positive integer) for parts associated with the first message M1 in the spool table 502. Likewise, the parts table 506 may also include a plurality of respective entries 510, 512 for parts associated with the remaining messages M2−MT in the spool table 502. A part further may contain certain common properties, e.g., the content-type, character set etc. and other optional properties.

The data store 500 further includes a fragments table 514 to store and associate one or more fragments 516 with respective parts of messages stored in the parts table 506. For instance, in the example illustrated, the fragments table 514 includes entries F11A-F11V (V being a positive integer) for fragments associated with the first part P11 of the first message M1 stored in the parts table 506. Similarly, the fragments table 514 may also include a plurality of respective entries 518, 520 for fragments associated with the remaining parts P12-P1U of the first message M1 stored in the parts table 506. The fragments table 514 may further include a plurality of respective entries 522, 524 for fragments associated with the respective parts 510, 512 of remaining messages M2−MT.

The data store also includes a separate property table 526 for storing content-based message properties which are made available for subscription filtering. These properties are stored for respective messages. Accordingly, in the example illustrated, a set 528 of properties 1−X (X being a positive integer) are stored for message M1 and a set 530 of propertied 1−Y (Y being a positive integer) are stored for message MT. Thus, one or more properties can be stored for each of the respective messages 504 in the spool table 502. It is to be appreciated, however, that for purposes of the present invention, not all of the messages are required to have entries in such a properties 526 table.

By way of example only, these properties may include a destination endpoint identifier, a preferred transport protocol, the message type, a message sender identifier, etc. Other properties 532 that may be of interest to recipients of messages (e.g., dates, times) but are not utilized for subscription filtering can be stored in the spool table 502. The set of properties stored in the property table 526 (e.g., which are promoted into the property table) is determined by examining subscription predicates. Subscription predicates, as discussed below, are essentially sub-components of conditions precedent in order for routing messages in accordance with an aspect of the present invention. It is to be appreciated that such a spool table 502, parts table 506, fragments table 514 and properties table 526 may be implemented, for example, by way data tables in of one or more SQL databases.

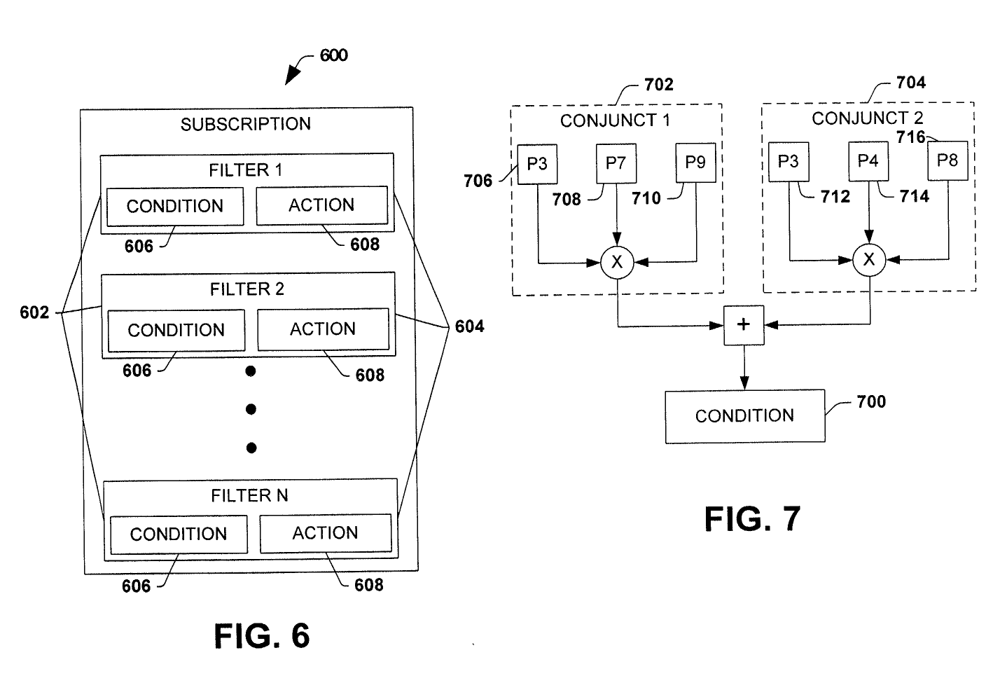

FIG. 6 illustrates an example of a subscription 600 which can be registered by a service in accordance with an aspect of the present invention. Subscriptions are designed to control routing of messages that satisfy certain property comparison criteria (e.g., match a set of message content criteria). Essentially, each respective subscription specifies a set of properties and comparison rules with fixed values, and identify destinations to which matching messages are to be routed. Subscriptions can be created either at deployment of a service or at runtime. In the example shown, the subscription 600 contains a plurality (e.g, 1−N, N being a positive integer) of filters 602. Each filter defines a condition, action pair 604. Conditions 606 determine whether messages should be routed based on a comparison of message properties and the conditions stated in the filter. Actions 608 designate where messages are to be sent when and if one or more associated conditions are satisfied. More particularly, action definitions carry, among other things, names and types of subscribing services and, in some cases, an identifier for a specific instance of a service type. In this manner, only messages having properties that match one or more subscription filters are sent to subscribing services identified by the action 608 in the respective filter(s).

Conditions are discussed in greater detail with respect to FIGS. 7-9. As depicted in FIG. 7, a condition 700 is defined in terms of one or more conjuncts 702, 704 which are themselves based on one or more predicates 706, 708, 710, 712, 714, 716. More particularly, a condition 700 is satisfied when one or more conjuncts 702, 704 are met, where conjuncts are a function of the state of one or more predicates 706, 708, 710, 712, 714, 716. A predicate, for example, is a simple comparison of message properties with constant values (e.g., =, >, <, !=, =, =, is null and exists). Alternatively or additionally, the comparison can be relative to a set of values, such as by defining a set of relationships using set theory. Thus, the exemplary condition 700 illustrated in FIG. 7 is satisfied when either CONJUNCT 1 or CONJUNCT 2 is met. And, CONJUNCT 1 is satisfied where predicate P3 and predicate P7 and predicate P9 are true, while CONJUNCT 2 is satisfied where predicate P3 and predicate P4 and predicate P8 are all true.

It is to be appreciated that, while three predicates are illustrated for each of the conjuncts 702, 704 in FIG. 7, a conjunct can include any number of one or more predicates. Similarly, conditions can depend on any number of one or more conjuncts (instead of two 702, 704, as depicted in FIG. 7). It is to be further appreciated that different conjuncts also can depend upon the same predicates. For instance, in the example illustrated in FIG. 7, both CONJUNCT 1 and CONJUNCT 2 rely upon the state of predicate P3.

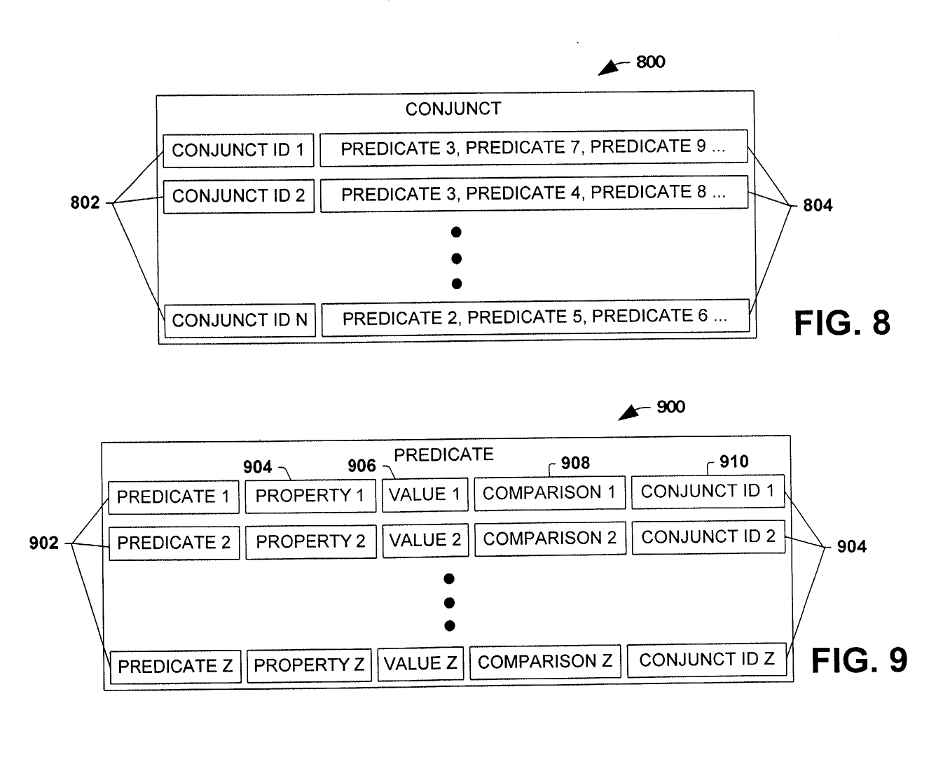

FIG. 8 illustrates a conjunct table 800 (e.g., populated in SQL, CGI, Perl or the like) that contains conjuncts in accordance with one or more aspects of the present invention. The conjunct table 800 includes a plurality (e.g., 1−N, N being a positive integer) of conjunct identifiers 802 along with respective predicates 804 corresponding to the conjunct identifiers 802. Each conjunct identifier, for example, can be a unique identifier associated with a particular combination of one or more predicates. In this manner, predicates belonging to the same conjunct can be grouped together utilizing a conjunct identifier. As mentioned above, more than one conjunct can include a particular predicate. For instance, in the example illustrated, PREDICATE 3 is associated with both CONJUNCT ID 1 and CONJUNCT ID 2.

FIG. 9 illustrates a predicates table 900 that contains predicates according to one or more aspects of the present invention. The predicates table 900 contains a plurality (e.g., 1−Z, Z being a positive integer) of predicates 902, such as are stored in an associated conjunct table (e.g., FIG. 8) in connection with one or more conjuncts. The predicate entries include corresponding entries for property 904, value 906, comparison operator 908 and conjunct identifiers 910 for respective predicates. Each property entry 904 refers to a particular content based message property that can be extracted from message content, as described herein.

For example, properties can include an identifier of a destination endpoint, a preferred transport protocol, the message type, an identifier of a message sender. Value entries 906 refer to fixed or constant values to which content-based message properties are to be compared. And, comparisons 908 correspond to relationships between the content-based message properties of the subscription and their associated values (e.g., =, >, <, !=, =, =, is null, and exists). Conjunct identifiers 910 identify the one or more conjuncts respective predicates are to be associated with. For instance, as illustrated in FIG. 8, PREDICATE 3 is associated with CONJUNCT ID 1 as well as CONJUNCT ID 2. It will be appreciated that the content-based properties necessary to populate the properties table referenced with respect to FIG. 5 and utilized in subscription filtering can be determined based on an examination of the property entries 904 in the predicates table 900.

It is to be appreciated that subscriptions can also carry properties, such as may provide information about the identity of the subscribing service, service type, security clearance of the subscriber and the like. Subscription properties may be stored in a table similar to message properties (see, e.g., FIG. 5).

As mentioned above, a message also can include a reverse filter to restrict which subscriptions are applied to the message according to an aspect of the present invention. The reverse filter of the message can include based on subscription properties just described. Thus, non-matching subscription are filtered out so as to be unable to access and evaluate such messages.

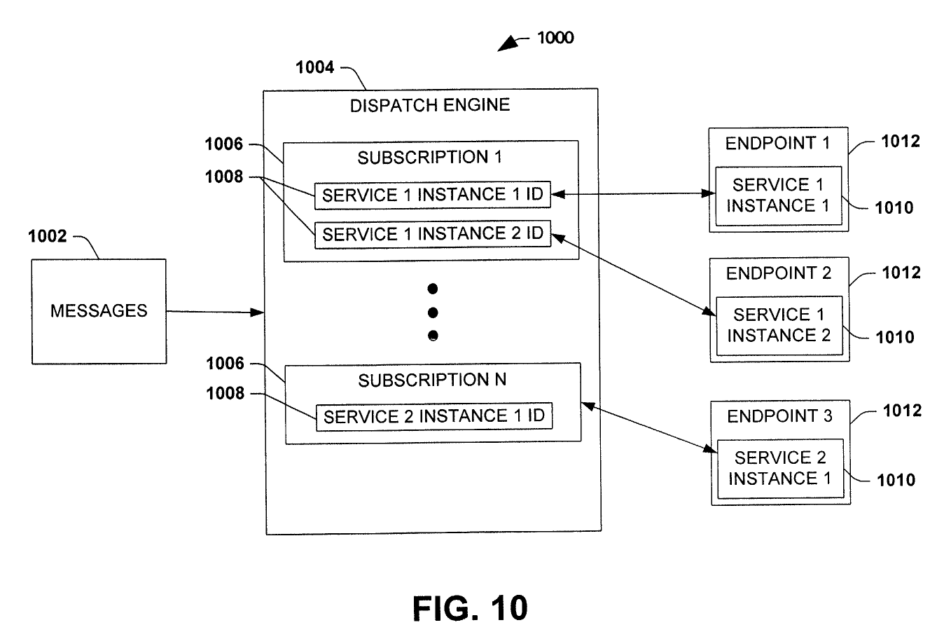

Turning to FIG. 10, a system 1000 for routing messages 1002 according to one or more aspects of the present invention is illustrated. The system 1000 includes a dispatch engine 1004 wherein a plurality (e.g., 1−N, N being an integer) of subscriptions 1006 are maintained. The subscriptions 1006 include one or more service instance identifiers 1008 corresponding to instances 1010 of services hosted on various endpoints 1012. The dispatch engine 1004 utilizes the instance identifiers 1008 to appropriately route messages 1002 to service instances 1010.

By way of example, since transactions frequently comprise multiple operations that may be performed by the same or different services hosted on different endpoints 1012, messages 1002 may need to be routed to respective service instances 1010 executing on different endpoints 1012. Thus, subscriptions 1006, which are specified by service instances 1010 desirous of receiving messages, may contain instance identifiers 1008 which are utilized to designate the particular instance of the service submitting the subscription. This information can be utilized by the dispatch engine 1004 in routing those messages 1002 that match criteria specified in the subscriptions 1006 to respective service instances 1010.

For example, a credit card verification performed with respect to a sales transaction may require that a message be routed to one instance of the transaction executing on one endpoint host at a first point in time, while another aspect of the sales transaction may require that a message regarding inventory management/updates be routed to a different instance of the transaction executing on a different endpoint host at a second point in time. Each service instance can dynamically create a subscription having a respective instance ID to ensure that messages having proper aspects of the transaction are routed to the different service instances.

By way of further example, some subscriptions may not carry an instance identifier (e.g. a NULL instance ID). Subscriptions that do not carry instance IDs are referred to herein as activation subscriptions, for example. Activation subscriptions cause a new instance identifier to be created on routing of a message through such a subscription. The instance identifier can be automatically created for these subscriptions, which are utilized to create service instances or to invoke stateless services, such as simple transformation services.

Transformation services are stateless services that typically only require activation subscriptions created at deployment time. Stateful services, on the other hand, (e.g., business processes, persistent ordered streams or persistent conversations between applications) carry instance identifiers to facilitate tracking state information. Essentially, service instances can be started in two ways. A service may be explicitly instantiated using some implementation-specific functionality or it may be implicitly instantiated with an operation in its behavior that is meant to be an instantiation operation.

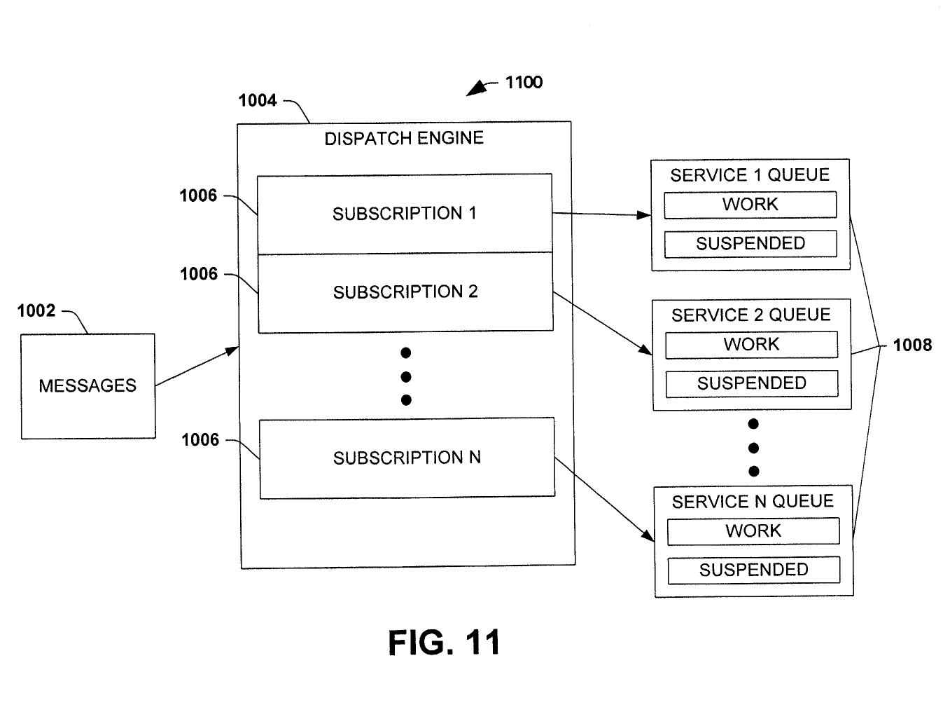

Turning to FIG. 11, a system 1100 for dispatching messages according to one or more aspects of the present invention is illustrated. A message 1102 is received by a dispatch engine 1104 that includes a one or more (e.g., 1−N, N being a positive integer) subscriptions 1106 comprising one or more filters (not shown). As described above, the subscription filters include condition, action pairs that indicate what action to perform on the message if the message properties satisfy the condition associated with the respective filter. That is, the action information in the filters identifies to where the dispatch engine 1104 is to route messages that satisfy their associated conditions. In the example of FIG. 11, the dispatch engine 1104 can pass messages to one or more queues 1108 based on the message properties satisfying respective condition(s) of filters in the subscriptions 1106. Each of the queues 1108 corresponds to a service, which can have plural instances, and each service is associated with one or more respective subscriptions. For example, a service can issue subscriptions associated a particular queue 1108 to facilitate additional control in dispatching the messages. The queues can include work queues 1110 and suspend queues 1112.

It is to be appreciated that subscriptions may be enabled or disabled based on a variety of factors, such as, for example, payment of subscription fees. As such, subscriptions that are enabled (or active) can cause messages to be placed into a work queue 1110 of the respective service. Subscriptions that are disabled (or inactive) can cause messages satisfying the inactive subscription to be placed into a suspended queue 1112 of the respective service. Items in the suspended queue 1112 can be programmatically moved to the work queue (e.g., after a fee is paid or a predetermined period of time lapses). For each subscription that matches a message, a separate work-item is created in the respective queue 1008. Thus, a subscription ID and message ID uniquely identifies a work queue item. Additionally, when a message reference is posted in the work queue, a unique work ID can be generated for the particular queue-entry.

It will be appreciated that while the service queues 1108 are illustrated as separate items in FIG. 11, the queues could be implemented be part of a dispatch engine (as shown), a data store (e.g., implemented in SQL or other appropriate server database system) and/or implemented at different endpoints in the communications framework.

Service instances frequently process aspects of a transaction autonomously to a well-defined beginning and end, and it is often desirable to perform such processing uninterrupted. For instance, where a service instance performs an inventory check to determine whether all of the items listed on a particular purchase order are available, it may be possible to mitigate inefficiencies by allowing the service to start at the beginning of the list and to matriculate straight through to the end of the list without stopping to check the availability of other items listed on different purchase orders.

To mitigate inefficiencies and facilitate uninterrupted message processing, instance identifiers may be associated with messages in service queues. More particularly, messages may be grouped according to instance identifiers in service queues 1108. This allows an instance identifier corresponding to a service instance to which a message has been dispatched, to be “locked” such that no other messages can be dispatched to that service instance until whatever processing the service instance performs on the dispatched message has been completed. Locking the instance identifier may also keep concurrent activations of the same service instance from occurring. After processing, the message may be removed from the service queue and the service instance can be unlocked so that a subsequent message can be dispatched to the service instance for processing. Grouping messages according to instance identifiers and tracking when messages are dispatched to service instances, mitigates concurrent dispatching of messages to the same service instances. Thus, service instances can process messages without being interrupted. Additionally, by associating messages with instance identifiers, the messages are not processed twice by multiple service instances. This may be important during scale-out where multiple instances of a service may be transacting on different endpoints across a server farm.

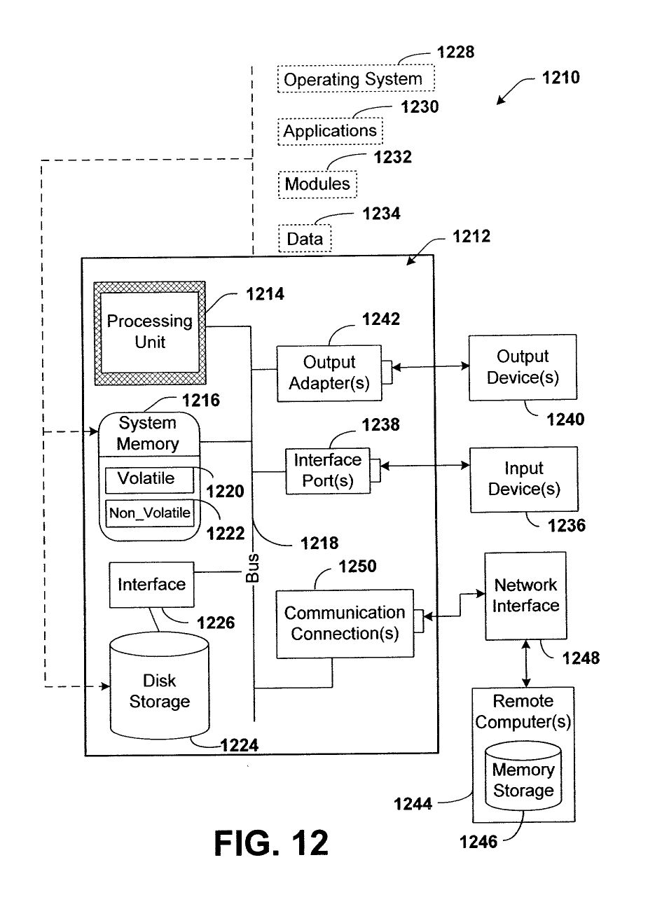

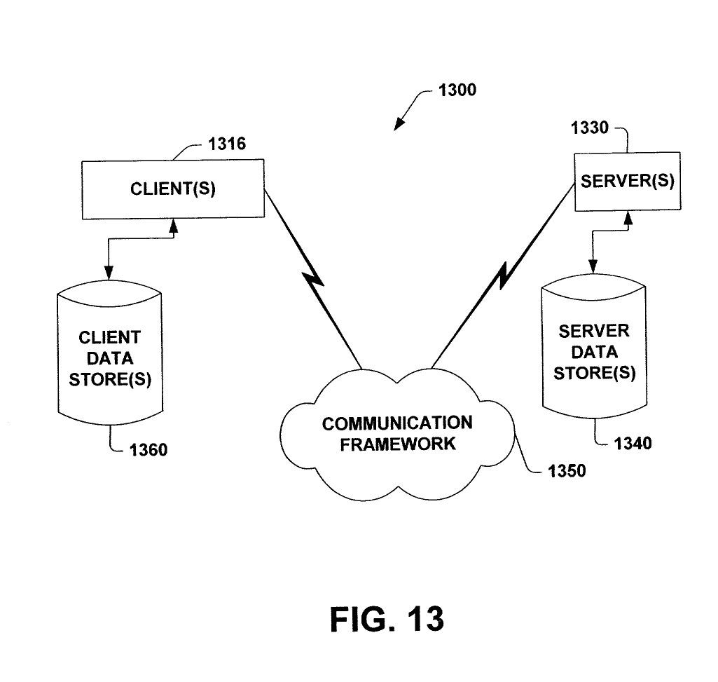

In order to provide a context for the various aspects of the invention, FIGS. 12 and 13 and the following discussion are intended to provide a brief, general description of suitable computing environments in which the various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 1210 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 15-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/nonremovable, volatile/nonvolatile computer storage media. FIG. 20 illustrates, for example a disk storage 1224. Disk storage 1224 includes, but is not limited to, devices like a magnetic disk drive, floppy disk drive, tape drive, Jazz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the present invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the possessing unit 1216 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE, Token Ring/IEEE and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 548 includes, for exemplary purposes only, internal and external technologies such as, modems including regular telephone grade modems, cable modems and DSL modems, ISDN adapters, and Ethernet cards.

FIG. 13 is a schematic block diagram of a sample computing system 1300 in which the present invention can be implemented. The system 1300 includes one or more client(s) 1310. The client(s) 1310 can be hardware and/or software (e.g., threads, processes, computing devices). The server(s) 1330 can also be hardware and/or software (e.g., threads, processes, computing devices). The system 1300 also includes one or more server(s) 1330. From a hardware perspective, it is to be appreciated that the clients and/or servant can be computers generally configured in the manner described above with respect to FIG. 12, although those skilled in the art will understand and appreciate various other configurations that could be utilized.

The server(s) 1330 can house threads to perform message processing by employing the present invention, for example. One possible communication between a client 1310 and a server 1330 may be in the form of a data packet adapted to be transmitted between two or more computer processes, such as, for example, posting a message, routing a message to a queue, or specifying a subscription. The system 1300 includes a communication framework 1350 that can be employed to facilitate communications between the client(s) 1310 and the server(s) 1330, as well as between servers. The client(s) 610 are operably connected to one or more client data store(s) 1360 that can be employed to store information local to the client(s) 1310. Similarly, the server(s) 1330 are operably connected to one or more server data store(s) 1340 that can be employed to store information local to the server(s) 1330. The data stores can store a message store, service class data, as well as state information.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. It is to be appreciated that frameworks, engines, handlers, transactions, services, systems can be components as that term is defined herein. A framework may be representative of a set of services providing the message processing functionality described herein.

It is to be appreciated that, for purposes of the present invention, any or all of the functionality associated with modules, systems and/or components discussed herein can be achieved in any of a variety of ways (e.g., combination or individual implementations of active server pages (ASPs), common gateway interfaces (CGIs), application programming interfaces (APIs), structured query language (SQL), component object model (COM), distributed COM (DCOM), system object model (SOM), distributed SOM (DSOM), ActiveX, common object request broker architecture (CORBA), database management systems (DBMSs), relational database management systems (RDBMSs), object-oriented database management systems (ODBMSs), object-relational database management systems (ORDBMs), remote method invocation (RMI), C, C++, practical extraction and reporting language (PERL), applets, HTML, dynamic HTML, server side includes (SSIs), extensible markup language (XML), portable document format (PDF), wireless markup language (WML), standard generalized markup language (SGML), handheld device markup language (HDML), graphics interchange format (GIF), joint photographic experts group (JPEG), binary large object (BLOB), other script or executable components.

In view of the foregoing structural, functional, and graphical features described above, methodologies in accordance with the present invention will be better appreciated with reference to FIGS. 13-18. Some functional aspects of the methodologies are represented as state diagrams, while other aspects are represented as flow diagrams. It is to be understood and appreciated that, while the flow diagrams are shown and described as executing serially, it is to be understood and appreciated that the present invention is not limited by the illustrated order, as some aspects could, in accordance with the present invention, occur in different orders and/or concurrently with other aspects from that shown and described herein. More generally, not all illustrated features may be required to implement a methodology in accordance with an aspect the present invention. It is further to be appreciated that the following methodologies can be implemented as computer-executable instructions, such as software stored in a computer-readable medium. Alternatively, the methodologies could be implemented as hardware or a combination of hardware and software.

The methodology may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired.

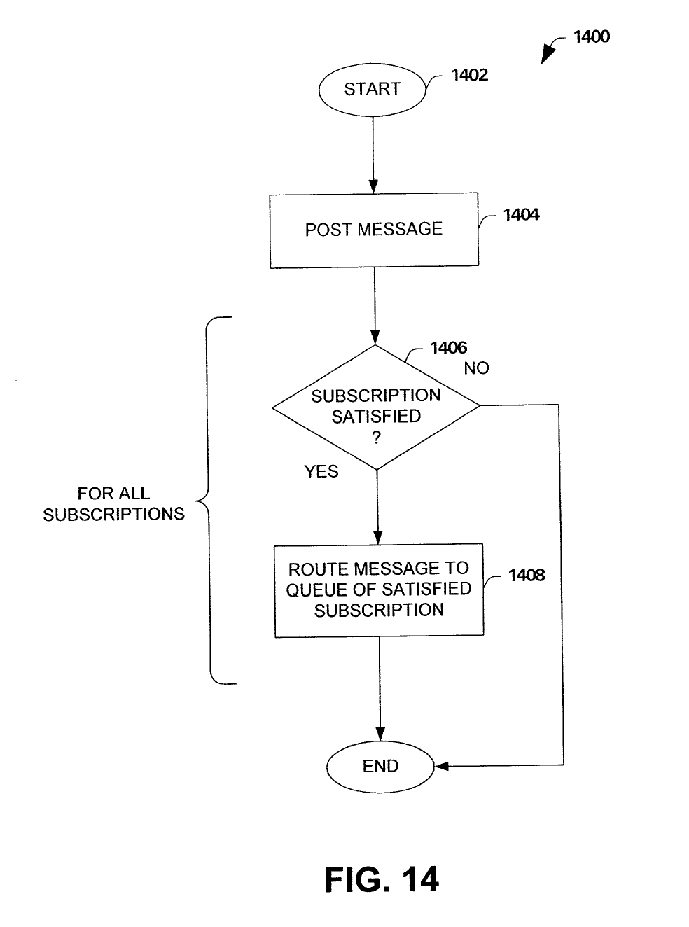

Turning to FIG. 14, a methodology 1400 for routing a message in accordance with one or more aspects of the present invention is illustrated. The methodology 1400 begins at 1402 in which the methodology is initialized. Then, at 1404 the message is posted to a data space (e.g., data store). The message being posted includes a message context having one or more properties extracted from an incoming message based at least in part on the content of the incoming message. The methodology then proceeds to 1406.

At 1406, a determination is made as to whether a subscription is satisfied by the message posted at 1404. The determination at 1406 is made for subscriptions that are applicable to the message, which can include all or a selected subset of the subscriptions. For example, the determination at 1406 is based on an evaluation of whether at least some of the message properties match the filter criteria of the subscription. If the determination at 1406 is affirmative, then the methodology proceeds to 1408. At 1408, the message is routed to a queue associated with the subscription satisfied at 1406. After 1408, the methodology proceeds to 1410 and ends. If the determination at 1406 is negative, indicating that the subscription is not satisfied by the message, the methodology proceeds to 1410 and ends. It is to be appreciated that, where more than one subscription exists, 1406 and 1408 can be implemented consecutively or concurrently for each available subscription.

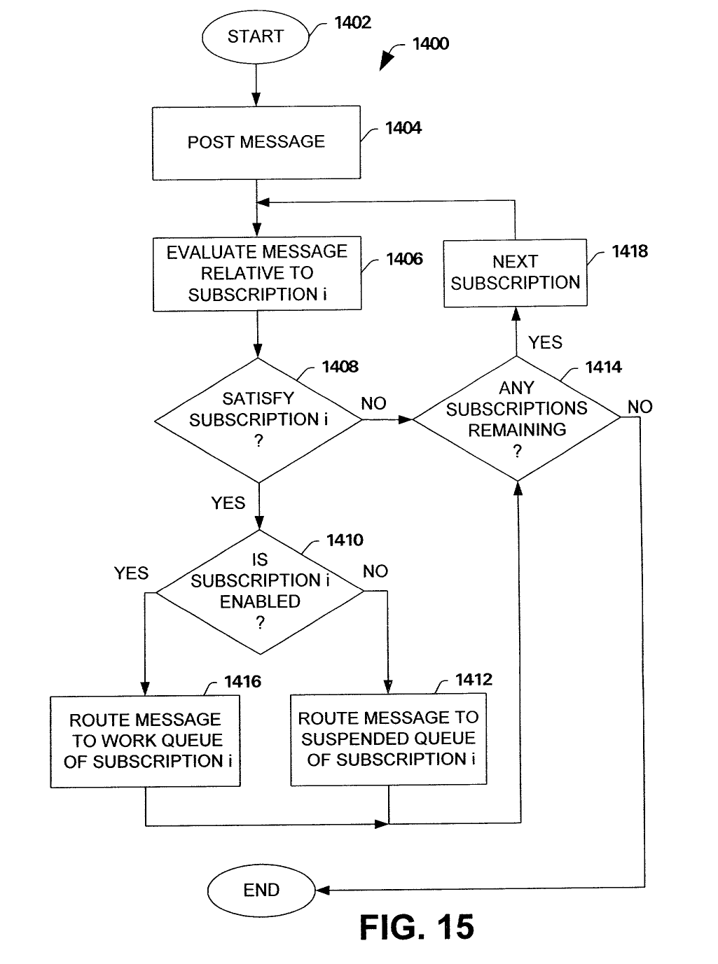

FIG. 15 illustrates a methodology 1500 for routing a message in accordance with an aspect of the present invention. The methodology begins at 1502 in which general initializations occur, such as upon activating a system to implement the methodology. Such initializations include, for example, allocating memory, establishing pointers, establishing data communications, acquiring resources, instantiating objects and setting initial values for variables.

Next, at 1504, a message is posted to a database or a collection of databases. For example, a main part of the message can be stored in a message spool data table with one or more associated parts of the message being populated in other data tables. The message includes a message identifier or ID that provides a reference for accessing the message. The message also includes a message context having one or more properties derived from content of an incoming message, which has been parsed to extract and identify desired properties thereof. Such content can include the message body of the incoming message as well as transport header information. The message properties further can include a reverse filter to selectively restrict which of a plurality of subscriptions may access the message for evaluation.

Next, at 1506, in response to posting the message, the message is evaluated relative to one or more subscriptions. However, if the message includes a reverse filter property, certain subscriptions may be selectively excluded from evaluation. In this way, the evaluation of the message by the available subscriptions can be facilitated as it may proceed for only a selected subset of the subscriptions. For purpose of the following example, the following discussion will be directed to processing a message relative to a subscription i, where i is a positive integer from 1 to N and N denotes the available subscriptions for the message.

Next, at 1508, a determination is made as to whether the message satisfies subscription i. The determination is based at least in part on a comparison or evaluation of at least some of the message properties relative to filter criteria of the subscription. As described herein, the filter criteria correspond to content-based properties and usually include the same (or similar) identifiers as used to derive the message properties (e.g., a predefined XML schema). If the determination at 1508 is affirmative, the methodology proceeds to 1510.

At 1510, a determination is made as to whether the subscription i is enabled or active. If the subscription is not enabled (inactive), the methodology proceeds to 1512 in which the message is routed to a suspended queue of the subscription i. From 1512, the methodology proceeds to 1514. If the determination at 1510 is affirmative, the methodology proceeds to 1516. At 1516, the message is routed to a work queue of the satisfied subscription i.

At 1514, a determination is made as to whether there are any additional subscriptions remaining for processing relative to the posted message. If there are additional subscriptions for processing, the methodology proceeds from 1514 to 1518 in which the next subscription i (i=i+1) is loaded for processing. From 1518, the methodology proceeds to 1506 in which that next subscription is evaluated relative to the message. If the determination at 1514 is negative indicating that there are no additional subscriptions for processing, the methodology proceeds to 1520 in which the methodology ends. It is to be appreciated that the determination at 1514 can be based on all available subscriptions or based on a selected subset of subscriptions, such as where the message includes a reverse filter. It is further to be appreciated that as described herein, all applicable subscriptions can process the message concurrently upon posting by obtaining a reference to the message or consecutively.

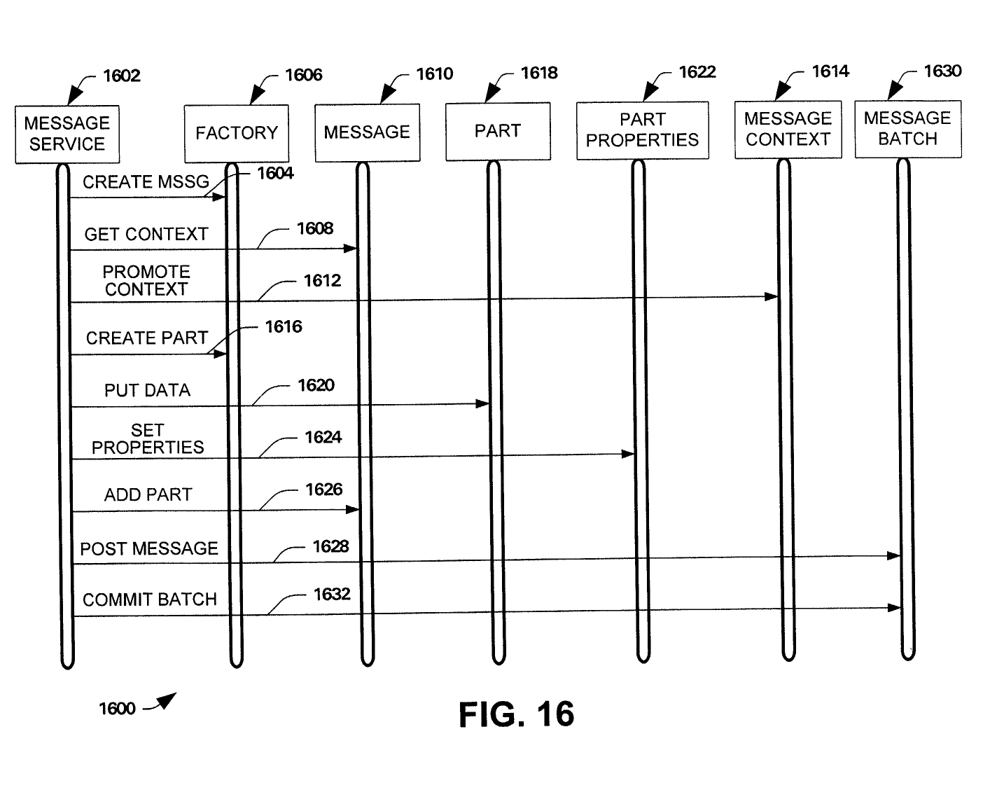

FIG. 16 illustrates an example of a methodology 1600 (represented as a process flow) that can be implemented to post a message to a data store for use in accordance with one or more aspects of the present invention. In response to receiving an incoming message, such as from an endpoint, a message service 1602 provides a create message request to an associated factory method 1606. It will be appreciated that the message service operates to issue requests to various methods and/or functions, as described below. The factory 1606 is programmed to generate blank interfaces for various parts of the message to enable posting the message into the database. For example, the message can be separated as a base message and one or more message parts and the factory 1606 can provide interfaces for the respective base message and any associated message parts.

The message service then issues a get context request 1608 to the respective message 1610. The context is then promoted at 1612 to a message context associated with the message 1610. The promotion 1612 can include all or a selected subset of the message properties of the message 1610, which selected properties can be set by the publisher of the message. Next, the message service 1602 issues a request (create part) 1616 to the factory 1606 to create one or more message parts 1618. Corresponding data is then populated to the part or parts at 1620. Each part 1618 also can include part properties 1622, which are set at 1624. After the part properties are set, the part just created is added to the message at 1626. Other parts can be created and populated in a similar manner. After all parts of the message 1610 have been created and added to the message, the message service issues a request (post message) 1628 to post the message 1610 to a batch process 1630. After the message is posted, the batch process can be committed at 1632 for processing according an aspect of the present invention.

It is to be appreciated that, depending on the perspective, a message can either represent the entire message in totality (e.g., all parts of the message in the single message object), or it may just represent a partial message. In the latter case, the full message gets written to the database through several message objects, and possibly over a lengthy period of time and from different sources. It is further to be appreciated that it in certain circumstances it may be desirable to prevent a messages from being posted, such as if there is no subscription for the message (e.g., at least one subscription may be required to enable a posting to occur). An exception may exist, however, such as when a publisher bypasses the normal subscription evaluation process and the message is sent directly to a corresponding application queue, or when a publisher completely bypasses the routing and creates the master entry only.

As mentioned above, subscriptions can be created either at deployment or at runtime. Essentially a subscription specifies a set of properties and the comparison rules with fixed values (e.g., a condition), and identifies the destination queue that the matching messages will be routed to if the subscription is satisfied (e.g. an action). A subscription also may contain information, such as the service class ID, service type, service instance, application instance and the like, which enables the message to be delivered to the proper destination. By way of example, a subscription with a NULL instance ID routes a message to any application that can handle the service type and, in turn, will be set with a corresponding instance ID. A subscription with a specific instance ID that is locked relative to a specific instance is routed only to the application running the specific instance of the service corresponding to the instance ID. It is to be appreciated, however, that any application can acquire an instance lock and will receive all messages for that instance until it releases the instance lock.

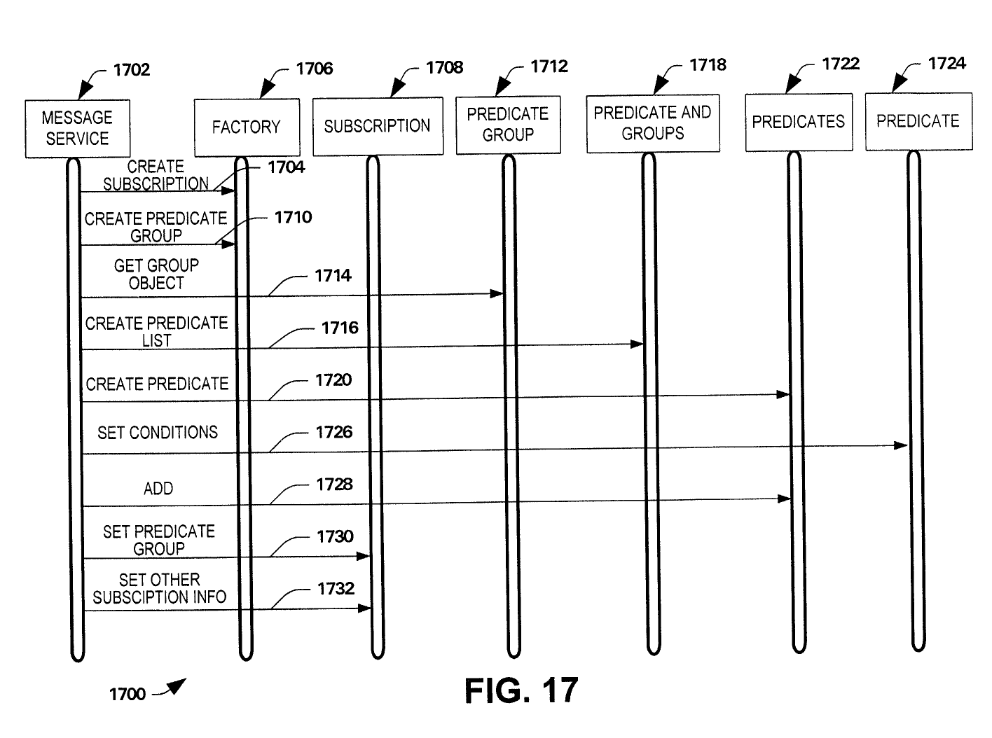

Turning to FIG. 17, an example of a workflow 1700 for generating a subscription at deployment in accordance with an aspect of the present invention is illustrated. While this example describes the subscription in the form of a Boolean expression having Boolean operators, those skilled in the art will understand that the present invention can be employed to implement other types of subscriptions.

The methodology employs a message service 1702 that issues a request (create subscription) to an associated factory method 1706. The factory 1706 instantiates a subscription object 1708 that exposes suitable interfaces to enable processing the respective subscription 1708. The message service 1702 also issues a request (create predicate group) 1710, which results in a corresponding predicate group 1712 being instantiated. Next, a group object is obtained via a get group object request 1714 provided to the predicate group 1712, such as to obtain an indication of disjunctive (e.g., AND) groups of the subscription. With the predicate group created, a predicate list is then created in response to a CREATE PREDICATE LIST request 1716 provided to a predicate and groups object 1718. The predicate list, for example, can be a single list for each respective OR group in the subscription.

A create predicate request 1720 is provided to a predicates object 1722, such as corresponds to a list of predefined predicates. The request 1720 results in a predicate object 1724 being instantiated. For example, plural predicates 1722 can be combined to form a conjunctive set (e g., an OR group) of the subscription. As mentioned above, each predicate can include a property (e.g., identified by name), a value for the property and an operator (e.g. =, <, >, ≈, ≠, =, =) that defines a relationship between the property and its value. Thus, after creating the predicate 1724, a set conditions request 1726 is provided to the predicate 1724 to set conditions thereof. For example, the conditions can correspond to the operators and/or values so as to define relationships between each property and value of the predicate 1724. The conditions also can correspond to setting AND conditions indicating which of the predicates 1722 are ANDed together to define a condition (or part of a condition) for the subscription.

After setting the conditions at 1724, the predicate 1726 is added to the list of predicates 1722 by and add request 1728. Next, a set predicate group request 1730 is provided to associate a corresponding predicate group with the subscription 1708. Thus, the subscription can include a single predicate or a plurality of predicates combined together (e.g., by Boolean operators) to form a condition of the subscription. Another request (set other subscription information) 1732 can be employed to set other properties or attributes of the subscription 1708. For example, the other subscription information can include an indication as to whether the subscription is enabled or disabled, an instance ID other property corresponding to the state of the subscription.

By way of illustration, when the instance ID of the subscription is not present (e.g., it is set NULL), the message is un-deterministically delivered to any eligible running application on any node. However, if the subscription contains the instance ID, messages that satisfy the subscription will be delivered only to the specific application process for the instance ID. For example, if the instance ID property is left NULL by a client, the corresponding subscription can be termed an “activation subscription”. A message matching this subscription activates a new service instance corresponding to the type of service that created the subscription (e.g., within the receiving service class). If more messages are expected for this instance, the service can dynamically create one or more additional subscriptions that route the new matching messages to this specific service instance by setting the instance ID property of the newly created subscription. Thus, new messages that match a subscription having an instance ID are always routed to the service currently processing the specific service instance corresponding to the instance ID.

It is also to be appreciated that subscriptions can be grouped together to form a subscription group. Within a group, subscriptions may have relative priority set. During subscription matching for a particular message, for example, only the top priority matching subscription(s) is considered for routing and the remaining low-priority matching subscriptions within the group can be discarded.

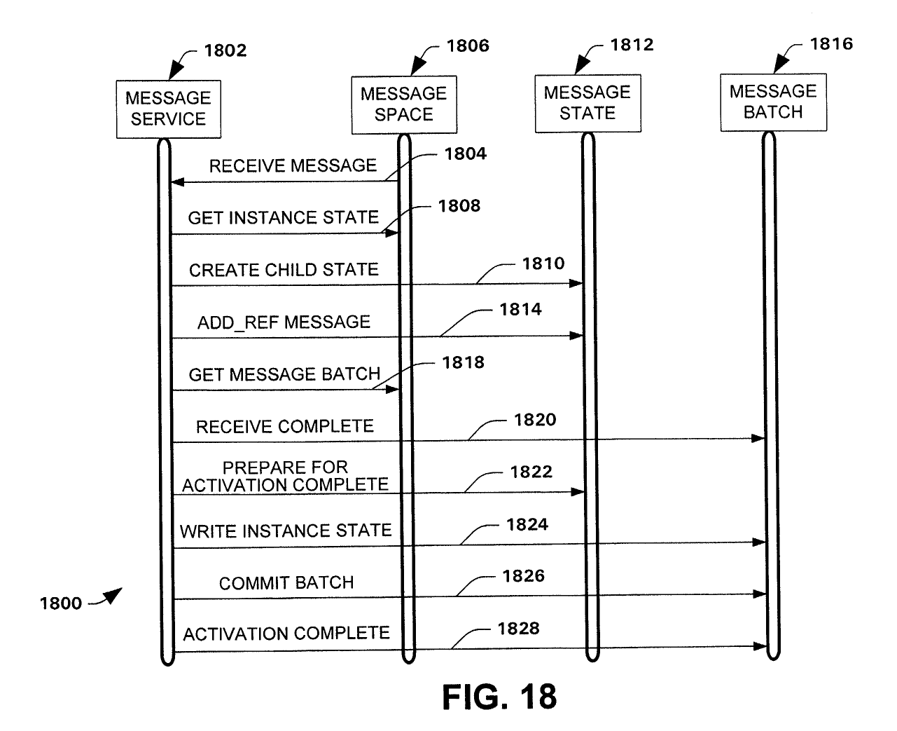

FIG. 18 illustrates a methodology 1800 corresponding to an instance of a service that can be employed in conjunction with a received message according to an aspect of the present invention. The methodology 1800 is activated in response to a message service 1802 receiving a message, indicated at 1804, from a message space object 1806 associated with a service. In response to receiving the message, the message service 1802 provides a request (GET INSTANCE STATE) 1808, to the message space object 1806 to create, for example, a master state associated with the instance of the service.

Next, one or more states can be created for the instance via a create child state request at 1810, which is provided to a message state object 1812, which can be instantiated in response to the GET INSTANCE STATE request 1808 to store state information associated with the service instance and message. The message state 1812 contains information about the specific instance of the service. A state may also contain a set of reference messages indicating, for example, that the message should be retained in the database and the service may need to retrieve these messages at a later time. Next, at 1814, the message is associated with the message state object 1812, such as according to a reference (e.g., message ID) of the message. A batch object 1816 is obtained in response to a GET MESSAGE BATCH request 1818.

The message batch object 1816 is processed by the service instance and appropriate messages are flagged as processed. In particular, a RECEIVED COMPLETE request 1820 is provided to the message batch to indicate that the service instance has completed its processing of the respective message. After the message has been processed by the service instance, the instance can enter a sleep or dehydration state, such as in response to a PREPARE FOR ACTIVATION COMPLETE request 1822 provided to the message state object 1812. In response to the request at 1822, the current instance state data can be written to the message batch object 1816, thereby preserving the current information associated with the service instance and corresponding message.

A COMMIT BATCH request 1826 also may be provided to the message batch 1816 to commit the respective batch. Depending on the type of message being processed, other information (e.g., transaction specific data) also can be associated with the message batch 1816 in conjunction with the COMMIT BATCH request 1826. If the batch is committed successfully at 1826, an ACTIVATION COMPLETE request at 1828 can be provided to release the instance lock between the message and the service instance. At this point, the service instance is taken out of memory and persisted in the database.

By way of further illustration, when a new message arrives at a later time and is intended for the same service instance, it can be delivered to one of the applications hosting the same service and service type. In response to such a message, a corresponding message batch object and service instance can be created based on the state information that was stored in the database in response to the prepare for activation complete request 1822. This results in a rehydration of the batch and state information that was stored. Those skilled in the art will understand and appreciate various ways in which such a rehydration process can be implemented.

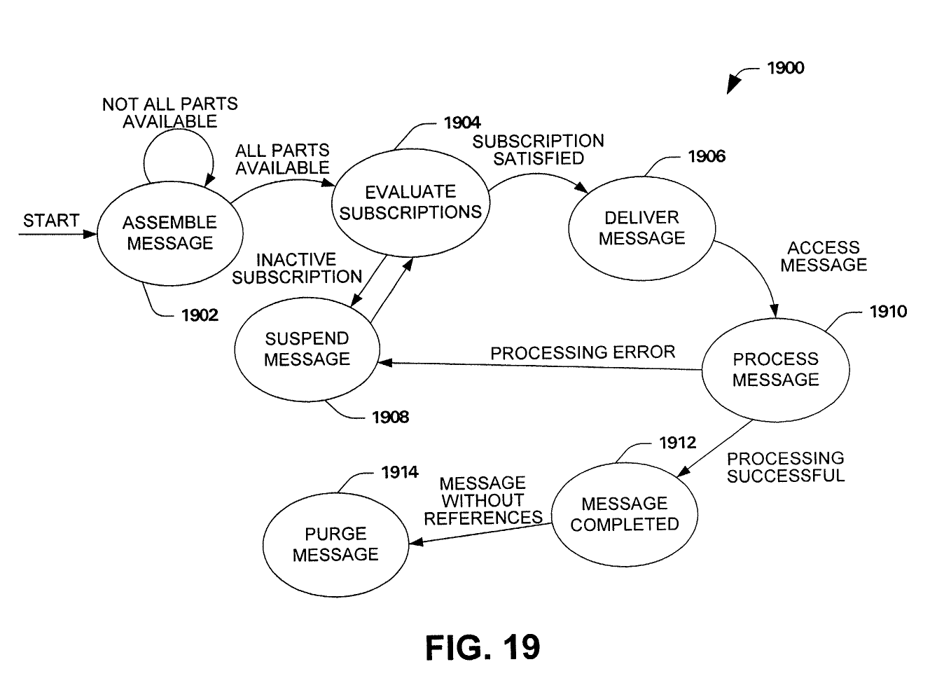

FIG. 19 is an example of a state diagram 1900 depicting various states and conditions associated with a lifecycle of a message implemented in accordance with an aspect of the present invention. The lifecycle starts, for example, in conjunction with a message being posted to an associated data space. For each message matching and active subscription, the message can be delivered to the appropriate service through a respective queue.

Turning to FIG. 19, after the message is posted, the message is in state 1902, in which the message is assembled. As mentioned above, the message includes a message ID associated with a main portion of the message, such as stored in a message spool table. The message also includes properties based at least in part on content of the message, as well as one or more other message parts, such as that provide a basis for such message content. The message remains in the assembled message state 1902 if not all parts are available for the assembly. Once all message parts are available, the message enters state 1904 to evaluate subscriptions relative to the message. In particular, each subscription includes one or more predicates, each of which include properties and associated values as well as an operator that identifies a relationship between the property and its associated value. Typically, the subscription can include more than one predicate combined in a variety of ways to define an associated condition. The corresponding properties of the message are evaluated relative to each subscription.

If the subscription or a selected portion thereof is satisfied by the message, the message enters 1906 in which the message is provided to a queue associated with the subscription that was satisfied. By way of illustration, each subscription can receive a reference to the message that is used to access and evaluate the respective subscription relative to the message. If a particular subscription is inactive, for example, the message may change from state 1904 to state 1908 in which the message is suspended, such as being provided to a suspended queue for that subscription. The message can change from a suspended state 1908 back to the state 1904, such as when the error is recoverable. The state change from 1908 to 1904 can occur in response to re-submitting the message to the subscriptions for evaluation.

Referring back to state 1906 in which the message has been queued, an appropriate service instance accesses the message from the cue for processing the message at state 1910. In order to track and synchronize message processing, a counter can be incremented when a message is added to the queue and decremented upon completion of its processing, for example.

From state 1910, if the processing is successful, the message enters state 1912 in which the processed message waits to be released from its lock with the associated service instance. Even though, in the message completed state 1912 the reference to the message being processed can be removed from the queue, a message master table still may contain a physical record of the message. If the reference count of the message is decremented to provide a NULL reference count, (e.g., indicating messages without references), the message can change from state 1912 to 1914. In state 1914, the message can be purged from the master table or message spool. It is also to be appreciated that parts having no references to any messages also can be periodically deleted from the database as well.

Back at the processing message state 1910, if an error occurs during processing, the message can enter the suspend message state at 1908, and if the error is recoverable can re-enter the evaluate subscriptions state 1904 by resubmitting the message for evaluation.

What has been described above includes exemplary implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A system to facilitate routing of messages, comprising:
at least one filter associated with a service, the at least one filter including filter criteria indicative of message content; and
a dispatch engine operative to receive a message and to route the message to the service based on at least some content of the message satisfying the filter criteria.

2. The system of claim 1 further comprising a plurality of filters, each having properties specified by one of a plurality of respective services, the properties being specified based on message content.

3. The system of claim 2, the dispatch engine correlating the message relative to at least some of the plurality of filters to discern whether to route the message to a service associated with a respective one of the at least some of the plurality of filters.

4. The system of claim 2, the message further comprising a set of properties derived based at least in part on the content of the message, the dispatch engine evaluating the plurality of filters relative to the message properties.

5. The system of claim 4, the message further comprising another set of message properties that restrict which filters are applied to the message.

6. The system of claim 1, further comprising a service queue associated with the at least one filter, the service queue being operative to receive messages from the dispatch engine that satisfy that at least one filter, such that the associated service can access the messages.

7. The system of claim 1, further comprising a filter generator invocable by the associated service to create the at least one filter by specifying what attributes of message content are sufficient to indicate that the dispatch engine is to route a given message to the associated service.

8. The system of claim 1, the filter criteria further comprising at least one identifier that corresponds to a predefined message property and a value associated with the at least one identifier.

9. The system of claim 1, the at least one filter further comprising at least one predicate that must be satisfied by the message to satisfy the filter.

10. The system of claim 9, the at least one predicate further comprising an identifier and associated value related to the identifier by an operator.

11. The system of claim 10, further comprising at least one conjunct that includes the at least one predicate to define a condition that can be satisfied to satisfy the filter criteria.

12. The system of claim 9, the at least one filter further comprising an associated action that is implemented by the dispatch engine in response to the message satisfying the at least one predicate of the at least one filter, whereby the at least one filter defines a condition-action pair.

13. The system of claim 12, the at least one filter further comprising an expression that includes a plurality of predicates in disjunctive form, each of the plurality of predicates comprising a property identifier, a value and a particular relationship between the property identifier and the respective value.

14. The system of claim 13, the expression further comprising at least one Boolean expression.

15. The system of claim 1, the at least one filter further comprising multiple filter phases associated with the service, the dispatch engine applying a first of the filter phases operative to identify if the message is a potential match for the service, and if the message satisfies the first filter phase, then applying at least another of the filter phases.

16. The system of claim 1, the message comprising message properties derived from and indicative of at least some of the content of the message, the dispatch engine evaluating the message properties relative to the filter criteria and providing the message to the service based on the evaluation.

17. The system of claim 16, further comprising a message service that parses an incoming message and extracts the message properties based at least in part on content of the incoming message, the message service posting the message including the message properties to a message space for evaluation relative to the least one filter.

18. The system of claim 17, the message service further extracting the message properties based on transport information in the incoming message.

19. The system of claim 17, the posted message being stored in the message space according to a common internal representation to facilitate evaluation relative to the at least one filter.

20. The system of claim 17, the extracted message properties being predefined by the service.

21. The system of claim 17, further comprising a plurality of filters, each of the plurality of filters having properties specified by one of a plurality of respective services to identify selected message content, the dispatch engine evaluating the message relative to at least some of the plurality of filters and providing the message to each service associated with a filter satisfied by the message.

22. The system of claim 21, the message properties defining a first set of message properties, the message further comprising a second set of properties that restricts which of the plurality of filters can be evaluated relative to the message.

23. The system of claim 16, each of the message properties further comprising an identifier-value pair, in which the identifier defines a property by name and the value identifies an associated value for the named property.

24. The system of claim 1, the at least one filter further comprising a plurality of filters having properties specified by respective services to identify selected message content, at least some of the plurality of filters being dynamically created and deleted at runtime.

25. The system of claim 1, further comprising a locking component associated with the service to acquire an instance lock between the message and an instance of the service if the message satisfies the at least one filter associated with the service and the dispatch engine provides the message to a queue for processing by the instance of the service, whereby the instance lock facilitates retrieval of relevant data for processing the message by the instance of the service.

26. The system of claim 25, the instance lock comprising instance data based on properties of the message to inhibit concurrent access to the message associated with a single service instance.

27. A system to facilitate routing of messages, comprising:
means for accessing a message that includes a message body and a message context, the message context having message properties based at least in part on content of the message body;
means for evaluating the message properties of the message relative to at least one subscription having filter criteria specified by at least one respective service; and
means for routing the message to the at least one respective service based on at least some of the message properties satisfying the filter criteria of the subscription.

28. The system of claim 27, the at least one respective service including a plurality of services, each of the plurality of services having a respective subscription used by the means for evaluating the message.

29. The system of claim 28, further comprising means for restricting relative to which of the plurality of subscriptions the message is evaluated

30. The system of claim 27, further comprising means for storing the message in response to the message satisfying the filter criteria to facilitate processing of the stored message by the one respective service.

31. The system of claim 30, further comprising means for locking the message relative to the one respective service to inhibit concurrent access to the message associated with a single instance of the one respective service, the means for locking being based on properties of the message.

32. The system of claim 27, further comprising means for extracting properties of the message based at least in part on the content of the message body and for storing a representation of the message that includes the extracted properties separately from and associated with other information of the message.

33. The system of claim 27, further comprising means for applying a first part of the filter criteria to ascertain whether the message is a potential match for the at least one service, and means for applying at least another part of the filter criteria provided that the message satisfies the part of the filter criteria.

34. The system of claim 27, further comprising means for at least one of dynamically creating and deleting subscriptions that have filter criteria specified by respective services, the means for evaluating further evaluating the message properties of the message relative to at least some of the subscriptions to determine if the message should be routed to any services associated with the at least some of the subscriptions.

35. A system to facilitate routing of messages, comprising:
means for receiving an incoming message and extracting properties of the message based at least in part on content of the message and storing a representation of the message that includes the extracted properties associated with other information of the message;
means for evaluating the extracted properties of the message relative to filter criteria specified by at least one associated service; and
means for routing the representation of the message to the associated service based on at least some of the extracted properties satisfying the filter criteria.

36. A method to facilitate dispatching messages, comprising:
accessing a message that includes a message body and a message context having message properties based at least in part on content of the message body;
evaluating the accessed message relative to at least one filter associated with a service, the at least one filter including filter criteria indicative of message content; and
routing the accessed message to the service based on at least some of the message properties satisfying the filter criteria.

37. The method of claim 36, the at least one filter further comprising a plurality of filters, each of the plurality of filters having properties specified by one of a plurality of respective services based on message content, the method further comprising:
evaluating the accessed message relative to at least some of the plurality of filters; and
providing the accessed message to each service associated with a filter satisfied by the message.

38. The method of claim 37, the evaluating further comprising correlating the properties of the accessed message relative to at least some of the plurality of filters to discern whether to route the accessed message to a service associated with a respective the least some of the plurality of filters.

39. The method of claim 37, further comprising parsing an incoming message having content and deriving a set of properties that define the properties of the accessed message based at least in part on the content of the incoming message.

40. The method of claim 39, further comprising restricting which of the plurality of filters are evaluated relative to accessed message according to another set of properties associated with the accessed message.

41. The method of claim 39, further comprising deriving the message properties based on transport information in the incoming message.

42. The method of claim 39, further comprising posting the accessed message in a message space according to a predetermined schema to facilitate evaluation of the accessed message relative to the at least one filter.

43. The method of claim 39, each of the properties in the set of properties being selected from a set of properties predefined by the service.

44. The method of claim 36, the routing further comprising storing the accessed message in a queue if the accessed message satisfies the filter criteria so as to facilitate processing of the message by the service.

45. The method of claim 44, further comprising locking the stored message relative to the one respective service to inhibit concurrent access to the store associated with a single instance of the one respective service, the locking being based on properties of the accessed message.

46. The method of claim 36, the filter criteria further comprising an expression that specifies property names, property values, and relationships of the property names relative to respective property values that are required for the accessed message to satisfy the filter criteria.

47. The method of claim 36, the method further comprising:
evaluating a first part of the filter criteria relative to the accessed message to identify if the accessed message is a potential match for the service; and
if the accessed message satisfies the first part of the filter criteria, evaluating at least another of the part of the filter criteria relative to the accessed message.

48. The method of claim 36, further comprising at least one of dynamically creating and deleting subscriptions that have filter criteria specified by respective services, the properties of the accessed message being evaluated relative to at least some of the subscriptions to determine if the message should be routed to any services associated with the at least some of the subscriptions.

49. A computer readable medium having computer executable instructions for:
accessing a message that includes a message body and a message context having message properties based at least in part on content of the message body;
evaluating the accessed message relative to at least one filter associated with a service, the at least one filter including filter criteria indicative of message content; and
routing the accessed message to the service based on at least some of the message properties satisfying the filter criteria.
